(19) United States
(12) Patent Application Publication
(10) Pub. No.: US 2025/0198095 A1
(43) Pub. Date: Jun. 19, 2025

(54) ROAD MACHINE AND ROAD SURFACE PAVING SYSTEM

(71) Applicant: SUMITOMO CONSTRUCTION MACHINERY CO., LTD., Tokyo (JP)

(72) Inventors: Hisaho MINO, Chiba (JP); Tota TERAMOTO, Chiba (JP)

(21) Appl. No.: 19/066,703

(22) Filed: Feb. 28, 2025

Related U.S. Application Data
(63) Continuation of application No. PCT/JP2023/034755, filed on Sep. 25, 2023.

(30) Foreign Application Priority Data
Sep. 29, 2022 (JP) 2022-156594

(51) Int. Cl. E01C 19/00; E01C 19/48

(52) U.S. Cl. CPC E01C 19/008; E01C 19/4873; E01C 2301/14

(57) ABSTRACT

A road machine includes a tractor, a screed disposed behind the tractor and configured to level a first paving material, and a working device configured to supply the first paving material in front of the screed, wherein the road machine is configured to perform a process for paving an area having milling marks with the first paving material based on the milling marks on a second paving material, the second paving material having been used to pave a road surface, and the milling marks being shown in image information captured by an imaging device.

### RELATED APPLICATION

This application is a continuation application of International Application no. PCT/JP2023/034755, filed on Sep. 25, 2023, and designated the U. S., which is based upon and claims priority to Japanese Patent Application no. 2022-156594, filed on Sep. 29, 2022, the entire contents of which are incorporated herein by reference.

### BACKGROUND

### Technical Field

The present invention relates to a road machine and road surface paving system.

### Description of Related Art

Conventionally, a road machine having a tractor, a screed disposed behind the tractor to level paving material, and a working device for supplying paving material in front of the screed, such as an asphalt finisher, is known.

The road machine moves along a road surface to be paved with paving material. Therefore, a technology for supporting a movement of the road machine has been proposed.

For example, in the technology described in a related art, after an optical sensor detects a travel reference line installed on a road surface and recognizes a lateral deviation of the asphalt finisher, a direction of wheels is changed to correct the deviation. Thus, the technology described in PTL 1 enables the asphalt finisher to move along the road surface.

### SUMMARY

A road machine includes a tractor, a screed disposed behind the tractor and configured to level a first paving material, and a working device configured to supply the first paving material in front of the screed, wherein the road machine is configured to perform a process for paving an area having milling marks with the first paving material based on the milling marks on a second paving material, the second paving material having been used to pave a road surface, and the milling marks being shown in image information captured by an imaging device.

### BRIEF DESCRIPTION OF THE DRAWINGS

FIG. 1 is a schematic diagram illustrating an example of a road surface paving system according to one embodiment;

FIG. 2A is a side view of an asphalt finisher according to one embodiment;

FIG. 2B is a top view of the asphalt finisher according to one embodiment;

FIG. 2C is a rear view of the asphalt finisher according to one embodiment;

FIG. 3 is a block diagram illustrating a configuration example of a controller of the asphalt finisher according to one embodiment and a device connected to the controller;

FIG. 4 is a drawing illustrating image information captured by a front camera of the asphalt finisher according to one embodiment;

FIG. 5 is a drawing illustrating a first example of a reference line generated for image information captured by an imaging device of the asphalt finisher according to one embodiment;

FIG. 6 is a drawing illustrating a second example of a reference line generated for image information captured by the imaging device of the asphalt finisher according to one embodiment;

FIG. 7 is a drawing describing steering angle control by a movement control part according to one embodiment;

FIG. 8 is a drawing illustrating a bird's-eye view image generated by an information control part according to one embodiment; and

FIG. 9 is a rear view of the asphalt finisher according to another embodiment.

### DETAILED DESCRIPTION

According to the related art, since a member representing the travel reference line is required to be installed on the road surface, when considering a burden on an operator, it is difficult to install the member on the milled surface after the paving material has been milled.

An aspect of the present invention provides a technology for reducing a workload when paving a milled surface by properly detecting the milled surface to be paved.

In the following, embodiments of the present invention will be described with reference to the accompanying drawings. Further, the embodiments described below are not intended to limit the invention but are examples, and all features and combinations thereof described in the embodiments are not necessarily essential to the invention. In addition, the same or corresponding components in each of the drawings are denoted by the same or corresponding reference numerals, and descriptions may be omitted.

### One Embodiment

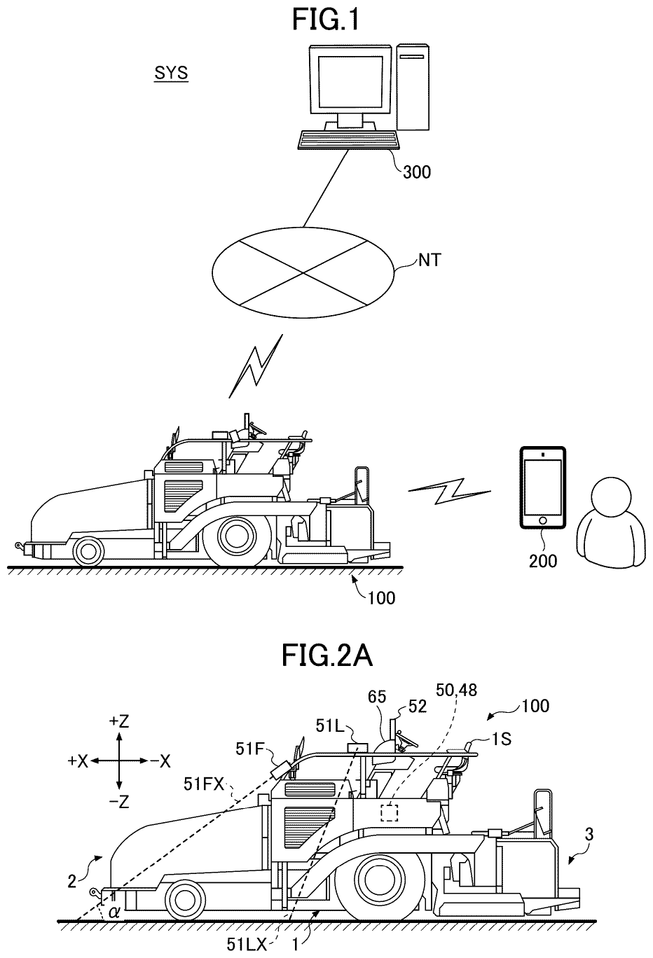

First, an outline of a road surface paving system SYS according to one embodiment will be described with reference to FIG. 1. FIG. 1 is a schematic diagram illustrating an example of a road surface paving system SYS according to one embodiment.

### <Equipment Included in Road the Surface Paving System>

As shown in FIG. 1, the road surface paving system SYS according to one embodiment includes an asphalt finisher 100, a communication terminal 200, and a remote management device 300 (an example of a communication terminal). The asphalt finisher 100 and the remote management device 300 are connected by a public network NT.

In addition, the road surface paving system SYS may, for example, perform various settings related to control of finisher the asphalt at 100 the communication terminal 200 in response to input from a user, or automatically, and transmit the settings to the asphalt finisher 100. Thus, various operations of the asphalt finisher 100 can be controlled or monitored from the communication terminal 200.

The asphalt finisher 100 may also transmit information indicating a current situation to one or more communication terminals 200 and/or a remote management device 300. Furthermore, the asphalt finisher 100 may transmit log information indicating the paving result of the road surface to one or more of the communication terminal 200 and the remote management device 300.

The remote management device 300 is a terminal provided for remote management of the work site. For example, the remote management device 300 manages an execution status by storing the log information transmitted from the asphalt finisher 100.

The communication terminal 200 is a terminal carried by a user who manages work at the work site, a user who performs work at the work site, or the like.

The communication terminal 200 receives image information showing the current execution status of the asphalt finisher 100 from the asphalt finisher 100 and displays it on a display device (liquid crystal panel) (not shown). Thus, the user managing work at the work site can recognize the current execution status of the asphalt finisher 100.

The road surface paving system SYS may include one or a plurality of communication terminals 200. Thus, the road surface paving system SYS can provide information about the asphalt finisher 100 to a plurality of users using each of the communication terminals 200.

The road surface paving system SYS may include one or a plurality of asphalt finishers 100. Thus, the road surface paving system SYS can collect data for the asphalt finisher 100, provide information to the user based on the collected data, and perform settings related to the control of the asphalt finisher 100. Next, a specific asphalt finisher 100 will be described.

### [Outline of the Asphalt Finisher]

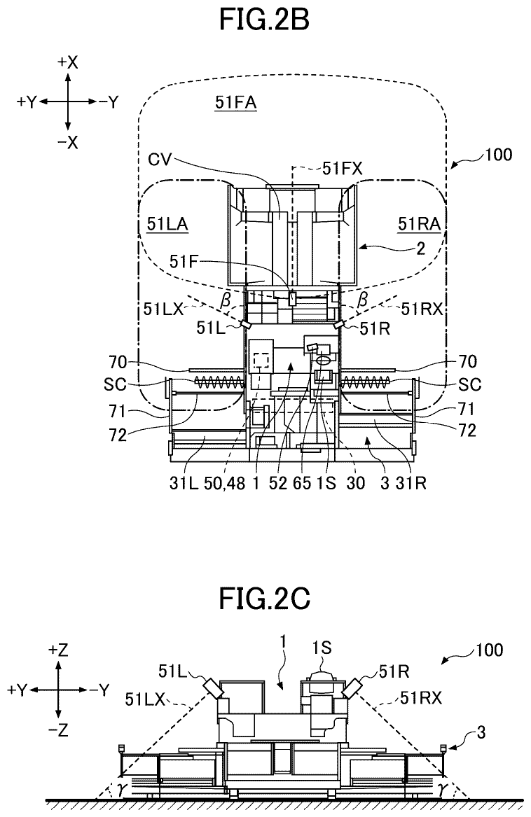

FIGS. 2A, 2B, and 2C show configuration examples of the asphalt finisher 100 as a road machine according to the present embodiment. FIG. 2A shows a side view, FIG. 2B shows a top view, and FIG. 2C shows a rear view.

The asphalt finisher 100 mainly includes a tractor 1, a hopper 2, and a screed 3.

The tractor 1 is a device for driving the asphalt finisher 100, and pulls the screed 3. In the present embodiment, the tractor 1 moves the asphalt finisher 100 by rotating two or four wheels using a traveling hydraulic motor. The traveling hydraulic motor rotates by receiving hydraulic fluid supplied from a hydraulic pump driven by a motor such as a diesel engine. A driver's seat 1S and an operation panel 65 are installed in the upper part of the tractor 1.

Imaging devices 51 (right camera 51R, left camera 51L, front camera 51F) are attached to the right lateral part, the left lateral part, and the front part of the tractor 1. A display device 52 is installed at a position easily visible to the driver seated in the driver's seat 1S. In the present embodiment, the direction of the hopper 2 as seen from the tractor 1 is forward (+X direction), and the direction of the screed 3 as seen from the tractor 1 is backward (−X direction). The +Y direction corresponds to the left direction, and the −Y direction corresponds to the right direction.

The hopper 2 as an example of a working device is a mechanism for receiving paving material (e.g., asphalt mixture). The working device is a device for supplying paving material in front of the screed 3. In the present embodiment, the working device is configured to be capable of opening and closing by a hydraulic cylinder in a vehicle width direction. The asphalt finisher 100 normally receives paving material from a loading bed of a dump truck with the hopper 2 fully opened. Then, when the paving material in the hopper 2 decreases, the hopper 2 is closed, and the paving material near the inner wall of the hopper 2 is collected in the center of the hopper 2, so that a conveyor CV, which is an example of the working device, can feed the paving material to the screed 3.

The screed 3 is a mechanism for leveling the paving material. In the present embodiment, the screed 3 is configured to be vertically movable, and to be extendable and retractable in the vehicle width direction by the hydraulic cylinder. The width of the screed 3 is larger than the width of the tractor 1 when extended in the vehicle width direction. In the present embodiment, the screed 3 includes a main screed 30, a left retractable screed 31L, and a right retractable screed 31R. The left retractable screed 31L and the right retractable screed 31R are configured to be extendable and retractable in the vehicle width direction (Y-axis direction). The left retractable screed 31L and the right retractable screed 31R, which are extendable and retractable in the vehicle width direction, are offset from each other in the traveling direction (X-axis direction). Therefore, they can have a longer width (length in the vehicle width direction) than when they are not offset and can be extended longer in the vehicle width direction, and a wider new pavement can be executed. The present embodiment has been described in the case where the screed 3 has a configuration that is extendable and retractable in the vehicle width direction. However, the present embodiment does not limit the screed 3 to a configuration that is extendable and retractable. In a variation, there is a method using a screed of fixed width in the asphalt finisher 100.

The controller 50 is a control part for controlling the asphalt finisher 100. The controller 50 is a computer including, for example, a CPU, a volatile memory, a nonvolatile memory, and the like. The controller 50 is a computer including a CPU and RAM, and is mounted in the tractor 1. Various functions of the controller 50 are achieved, for example, by the CPU executing a program stored in an auxiliary storage device 48.

The auxiliary storage device 48 is a device for storing various types of information. In the present embodiment, the auxiliary storage device 48 is a nonvolatile memory and is integrated into the controller 50. However, the auxiliary storage device 48 may be arranged outside the controller 50 as a structure separate from the controller 50.

The imaging device 51 is attached to the tractor 1. The imaging device 51 is configured to acquire information about a space around the asphalt finisher 100 and output the acquired information to the controller 50. The imaging devices 51 according to the present embodiment include a front camera 51F, a left camera 51L, and a right camera 51R. An imaging device 51 may be attached to positions other than the right lateral part, the left lateral part, and the front part of the tractor 1 (e.g., the rear part), for example. The imaging device 51 may be equipped with a wide-angle lens or a fisheye lens. The imaging device 51 may be attached to the hopper 2 or the screed 3.

The imaging device 51 according to the present embodiment is a camera equipped with an imaging element such as a CCD or CMOS, for example. The imaging device 51 may be a space recognition device capable of recognizing a space with reference to the asphalt finisher 100, for example, there is a method using LIDAR.

The imaging devices 51 according to the present embodiment include the front camera 51F, the left camera 51L, and the right camera 51R. As shown in FIGS. 2A and 2B, the front camera 51F is mounted on the front upper end of the tractor 1, and is mounted so that its optical axis 51FX extends forward in the traveling direction and forms an angle α in the side view with respect to the road surface. The left camera 51L is mounted on the upper end of the left lateral part of the tractor 1, as shown in FIGS. 2A to 2C, and is mounted so that its optical axis 51LX forms an angle β in the top view with respect to the left lateral part of the tractor 1 and an angle γ in the rear view with respect to the road surface. The right camera 51R is mounted in the same way as the left camera 51L but with the left and right reversed. In FIG. 2B, the area 51FA surrounded by a dashed line indicates the imaging range of the front camera 51F, the area 51LA surrounded by the dashed line indicates the imaging range of the left camera 51L, and the area 51RA surrounded by a long dashed short dashed line indicates the imaging range of the right camera 51R.

The imaging device 51 is mounted to the asphalt finisher 100 via, for example, a bracket, stay, bar, or the like. In the present embodiment, the imaging device 51 is mounted to the tractor 1 via a mounting stay. However, the imaging device 51 may be directly mounted to the tractor 1 without the mounting stay, or may be embedded in the tractor 1.

In the present embodiment, the imaging device 51 outputs the acquired input image to the controller 50. When an input image is acquired using a fisheye lens or a wide-angle lens, the imaging device 51 may output a corrected input image, in which apparent distortion or tilting effects caused by using those lenses are corrected to the controller 50. Alternatively, the input image in which the apparent distortion or tilting effects are not corrected may be output as it is to the controller 50. In this case, the apparent distortion or tilting effects are corrected by the controller 50.

The display device 52 is a device for displaying various types of information. In the present embodiment, it is a liquid crystal display installed on the operation panel 65 and displays various types of images output by the controller 50.

A retaining plate 70 is a plate-shaped member for preventing the paving material fed in the vehicle width direction by a screw SC from being scattered in front of the screw SC so that the paving material is properly fed in the vehicle width direction by the screw SC.

A side plate 71 is also attached to a distal end of a mold board 72. The mold board 72 is a member for adjusting an amount of paving material remaining in front of the left retractable screed 31L and the right retractable screed 31R out of the paving material spread by the screw SC, and is configured to be extensible in the vehicle width direction together with the left retractable screed 31L and the right retractable screed 31R.

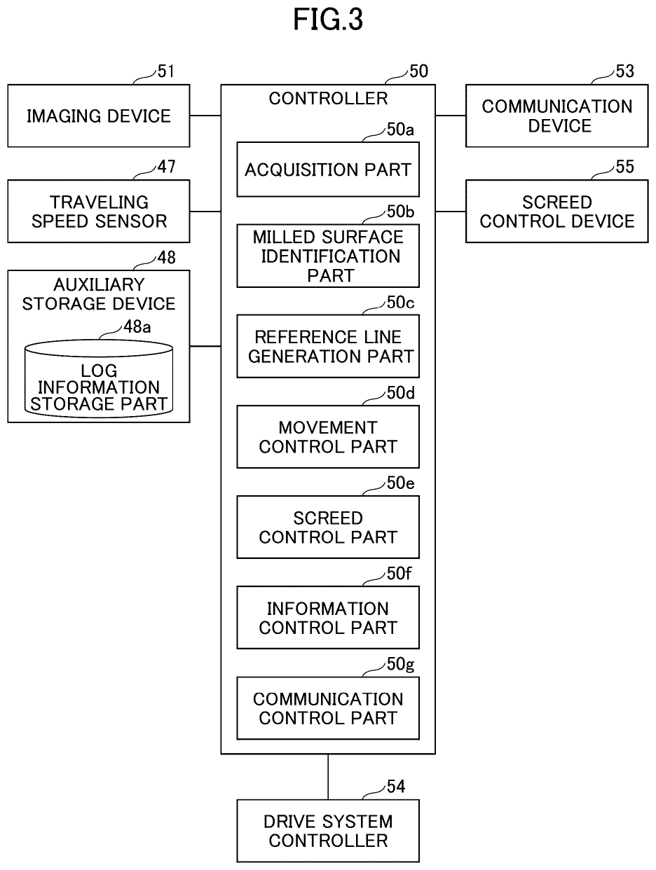

Next, the controller 50 mounted on the asphalt finisher 100 will be described with reference to FIG. 3. FIG. 3 is a block k diagram illustrating a configuration example of the controller 50 of the asphalt finisher 100 according to the present embodiment and devices connected to the controller 50.

The traveling speed sensor 47 is configured to detect the traveling speed of the asphalt finisher 100. In the example shown in FIG. 3, the traveling speed sensor 47 is an encoder for detecting angular speed of a rotary shaft of the rear wheel traveling motor that drives the rear wheels of the tractor 1. The traveling speed sensor 47 may be configured with a proximity switch or the like for detecting a slit formed in the rotary plate.

In the example shown in FIG. 3, the auxiliary storage device 48 stores the log information storage part 48a. The log information storage part 48a stores log information which is an execution result of the asphalt finisher 100. The log information will be described later.

A communication device (an example of a communication part) 53 performs wireless communication with a device which exists around the asphalt finisher 100 or a server or the like which manages the work site. In the present embodiment, one or more of Wi-Fi (registered trademark), wireless LAN, Bluetooth (registered trademark), or the like may be used as a wireless communication standard of the communication device 53.

The screed control device 55 is configured to control an extension and retraction amount of the left retractable screed 31L and the right retractable screed 31R. In the example shown in FIG. 3, the screed control device 55 controls a flow rate of the hydraulic fluid flowing into the screed extension and retraction cylinder which extends and contracts each of the left retractable screed 31L and the right retractable screed 31R (not shown). In response to a control command from the controller 50, the screed control device 55 switches between communication and interruption of a pipeline connecting a rod-side oil chamber of the screed extension and retraction cylinder and the hydraulic pump. Thus, extension and retraction of the left retractable screed 31L and the right retractable screed 31R can be achieved.

A drive system controller 54 controls the tractor 1 according to the control command. For example, the drive system controller 54 controls a rotation of the rear wheel traveling motor of the tractor 1 (speed control) and controls a steering angle of the front wheel of the tractor 1 (example of a driving wheel) in accordance with the steering angle and speed indicated by the control command.

More specifically, the controller 50 has an acquisition part 50a, a milled surface identification part 50b, a reference line generation part 50c, a movement control part 50d, a screed control part 50e, an information control part 50f, and a communication control part 50g as functional blocks including software, hardware, or combinations of the software and the hardware.

The acquisition part 50a acquires various types of information. The acquisition part 50a acquires detection information from various sensors. For example, the acquisition part 50a acquires image information captured by the imaging device 51 (front camera 51F, left camera 51L, and right camera 51R). The acquisition part 50a acquires detection information (including, e.g., a speed of the asphalt finisher 100) detected by the traveling speed sensor 47. The acquisition part 50a acquires steering angle information from the tractor 1.

In the present embodiment, movement control of the asphalt finisher is performed based on image information captured by the imaging device 51.

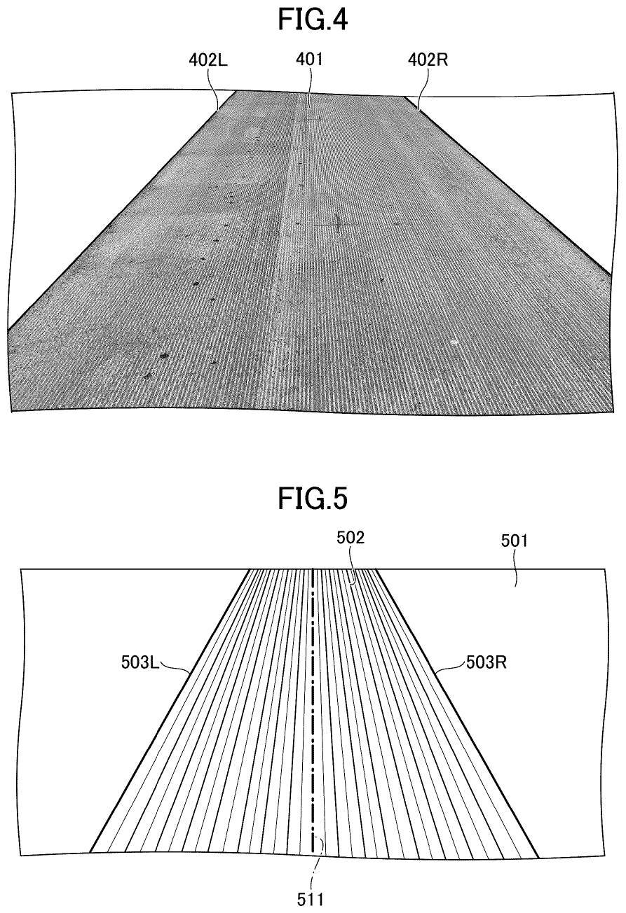

FIG. 4 is a drawing illustrating image information captured by the front camera 51F of the asphalt finisher 100 according to the present embodiment. In the image information shown in FIG. 4, the configuration of the asphalt finisher 100 captured in the image information is omitted for ease of description.

The present embodiment is an example in which the asphalt finisher 100 performs an operation on an area where the paving material has been milled by a road surface milling machine.

The example shown in FIG. 4 shows the area 401 where the paving material was previously milled by the road surface milling machine. Hereinafter, the area where the paving material was milled from the existing road surface by the road surface milling machine is referred to as a milled surface. As shown in FIG. 4, when the road surface milling machine mills the existing pavement surface (an example of the road surface paved with the second paving material) by several centimeters, milling marks appear on the milled surface 401.

In the example shown in FIG. 4, the milling marks of the milled surface 401 appear as streaks that are approximately parallel to the direction in which the road surface milling machine is moving. The milling mark is a mark that appears when the paving material is milled from the existing pavement surface, and is shown, for example, as a plurality of streaks following the traveling direction of the road surface milling machine. Shapes and intervals of the plurality of streaks vary depending on a type of the road surface milling machine. The streaks of the milling marks include, for example, a combination of one or more of a plurality of straight lines and a plurality of ellipses.

Since the milled surface 401 is an area where the existing pavement has been milled, the milled surface 401 is an area to be paved by the asphalt finisher 100. Therefore, in the present embodiment, the area where the milling marks are shown in the image information captured by the front camera 51F is identified as the milled surface, or in other words, the area to be paved.

That is, the controller 50 of the asphalt finisher 100 according to the present embodiment performs control to pave the area where the milling marks appear in the image information captured by the front camera 51F with the paving material (first paving material). Note that, the milling marks shown in FIG. 4 are shown as an example and differ depending on the type of the road surface milling machine. However, since the milling marks occur depending on the road surface milling machine, the area where the road surface milling machine has milled can be found based on the image information regardless of the type of the road surface milling machine.

Conventionally, the area to be paved is identified by detecting a difference in level from a road shoulder with a stereo camera or the like. However, in the work environment, it is sometimes difficult to detect the difference in level with the stereo camera or the like from above. Therefore, in the present embodiment, as an example, the milled surface is identified based on the milling marks shown in the image information.

Then, the milled surface identification part 50b of the controller 50 identifies the milled surface 401 having the milling marks based on the image information captured by the front camera 51F acquired by the acquisition part 50a. As for the method of identifying the milled surface 401, any method may be used as long as an identification method is based on the milling marks of the paving material represented in the image information. For example, there is a method in which the milled surface identification part 50b identifies the milled surface 401 by pattern matching with respect to the milling marks of the paving material shown in the image information. In order to perform pattern matching, the image information showing the milling marks is stored in the auxiliary storage device 48 in advance. Then, the milled surface 401 is identified by comparing the image information stored in the auxiliary storage device 48 with the image information captured by the front camera 51F. As another example, there is a method in which the milled surface identification part 50b identifies the milled surface 401 based on feature information of each area included in the image information. When the feature extracted from the image information to each area is similar to the feature representing the milling marks by a predetermined threshold or more, the milled surface identification part 50b identifies the area as the milled surface 401. The feature representing the milling marks is previously stored in the auxiliary storage device 48. As another example, there is a method in which the milling marks represented in the image information are identified using a trained model acquired by machine learning.

In this method, the milled surface identification part 50b inputs the image information captured by the front camera 51F to the trained model, identifying the milled surface based on the trained model's output result. The specific procedure of this method will be described with the following variations. At this time, the milled surface identification part 50b also identifies boundary lines 402L and 402R between the milled surface 401 and the road shoulder. In other words, the milled surface identification part 50b identifies the width of the milled surface in a horizontal direction with reference to the asphalt finisher 100 according to whether the milling marks exist or not.

The present embodiment has described a method in which the milled surface identification part 50b identifies the milled surface 401 based on the milling marks. However, the present embodiment is not limited to a method in which the milled surface 401 is identified based on the milling marks. As a variation, there is a method in which the controller 50 identifies the boundary lines 402L and 402R based on a difference between an area including the milling marks of the paving material shown in the image information and an area without the milling marks shown in the image information.

Referring back to FIG. 3, the reference line generation part 50c generates a reference line (an example of a path) that serves as a reference when the asphalt finisher 100 moves based on the identified milled surface 401. The reference line according to the present embodiment is a line that serves as a reference when the center of the asphalt finisher 100 moves. The center of the asphalt finisher 100 according to the present embodiment is, for example, the center position of the asphalt finisher 100 in the traveling direction and the width direction. The center of the asphalt finisher 100 may be a reference position when the movement control is performed, and may be, for example, the center position of the center of gravity when no paving material or the like is loaded.

Any method of generating a reference line by the reference line generation part 50c according to the present embodiment may be used. For example, the reference line generation part 50c may use the center line between the boundary lines 402L and 402R of the milled surface 401 identified by the milled surface identification part 50b as the reference line. Further, as a variation, there is also a method in which the reference line generation part 50c generates a reference line so as to be at the center of the milled surface 401 and along a path represented by streaks represented as milling marks of the milled surface 401.

FIG. 5 is a drawing illustrating a first example of the reference line generated for image information captured by the imaging device of the asphalt finisher 100 according to the present embodiment. In the image information 501 shown in FIG. 5, the configuration of the asphalt finisher 100 captured in the image information is also omitted.

In the example shown in FIG. 5, the milling marks are represented as streaks in a depth direction from the front. Based on whether the milling marks exist or not, the milled surface identification part 50b identifies the milled surface 502 of the image information 501 as well as the boundary lines 503L and 503R. Then, the reference line generation part 50c generates the reference line 511 (an example of the path) so as to pass through the center of the milled surface 502 based on the direction of the streaks represented on the milled surface 502 and the boundary lines 503L and 503R.

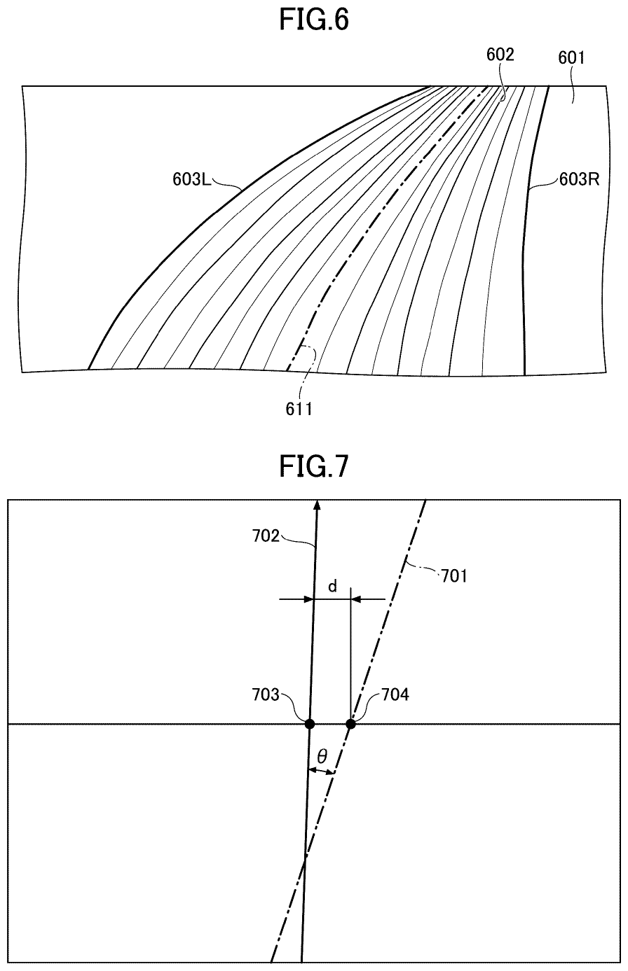

FIG. 6 is a drawing illustrating a second example of the reference line generated for the image information captured by the imaging device of the asphalt finisher 100 according to the present embodiment. In the image information 601 shown in FIG. 6, the configuration of the asphalt finisher 100 captured in the image information is also omitted.

In the example shown in FIG. 6, the milled surface 602 is curved in the right direction, and the streaks represented as milling marks are also curved in the right direction. The milled surface identification part 50b identifies the milled surface 602 of the image information 601 and the boundary lines 603L and 603R based on presence or absence of milling marks. Then, the reference line generation part 50c generates a reference line 611 (an example of a path) so as to pass through the center of the milled surface 602 based on the direction of the streaks represented on the milled surface 602 and the boundary lines 603L and 603R.

Referring back to FIG. 3, the movement control part 50d outputs a control command indicating the steering angle and speed to the drive system controller 54 so as to move along the generated reference line. As a result, the asphalt finisher 100 performs automatic movement control so as to perform paving on the milled surface.

FIG. 7 is a drawing describing steering angle control by a movement control part 50d according to the present embodiment. In the example shown in FIG. 7, the reference line 701 shown in FIG. 7 shows, for example, a part of the reference line 611 generated by the above-described process by the reference line generation part 50c. The vehicle body center line 702 shown in FIG. 7 is a line shown so as to pass through the center of the vehicle body in the vehicle width direction of the asphalt finisher 100.

In the case shown in FIG. 7, the movement control part 50d recognizes that the position coordinates 703 indicating the center of the current asphalt finisher 100 and the position coordinates 704 on the reference line 701 are deviated by a deviation amount d. Furthermore, the movement control part 50d recognizes an angle θ between the reference line 701 and the vehicle body center line 702. Then, the movement control part 50d calculates the steering angle of the tractor 1 such that the deviation amount d and the angle θ are corrected. As a calculation method of the steering angle such that the deviation amount d and the angle θ are corrected, a well-known method may be used; accordingly, description of the calculation method will be omitted.

As described above, in the present embodiment, as a process for paving the milled surface with a paving material, for example, the movement control part 50d performs steering angle control and speed control such that the tractor 1 is moved along a reference line determined based on the milled surface. Thus, since the milled surface can be properly detected and paved, the paving accuracy can be improved. In the present embodiment, as a process for paving the milled surface with a paving material, an example of moving the tractor 1 along a reference line determined based on the milled surface will be described. However, in the present embodiment, the process for paving the milled surface with a paving material is not limited to the process for moving the tractor 1 along a reference line determined based on the milled surface, but may be a process for spreading the paving material on the milled surface identified based on image information and paving it with the paving material. For example, the present embodiment is not limited to the process for generating a reference line at the center of the milled surface in the vehicle width direction. As a variation, there is a method in which the movement control part 50d moves the tractor 1 using the boundary line at the end of the milled surface. Specifically, there is a method in which the movement control part 50d calculates the deviation between the boundary line and the end of the retractable screed 31, and controls one or more of the steering angle of the tractor 1, and the extension and retraction of the retractable screed 31 so as to reduce the deviation.

Referring back to FIG. 3, the screed control part 50e outputs a control command to extend and contract the retractable screed 31 to the screed control device 55 based on the boundary line (example of the length of the milled surface in the vehicle width direction) identified by the milled surface identification part 50b so as to correspond to the width of the road surface on which the paving material is spread. Thus, since the length of the screed 3 in the vehicle width direction can be made to correspond to the width of the milled surface, the paving material can be properly leveled on the road surface to be paved. Furthermore, the workload for carrying out extension and retraction control of the retractable screed 31 can be reduced.

The present embodiment has described an example of extending and contracting the retractable screed 31 in order to make the length of the screed 3 in the vehicle width direction correspond to the width of the milled surface. However, the present embodiment is not limited to an example of extending and contracting the retractable screed 31. As a variation, when the width of the milled surface is constant, there is a method in which the asphalt finisher 100 uses a screed of fixed width corresponding to the width of the milled surface to level the paving material evenly.

The information control part 50f performs various controls on the information acquired by the acquisition part 50a.

For example, the information control part 50f generates bird's-eye view image data from the asphalt finisher 100 with a predetermined height as a viewpoint based on the image information acquired by the acquisition part 50a.

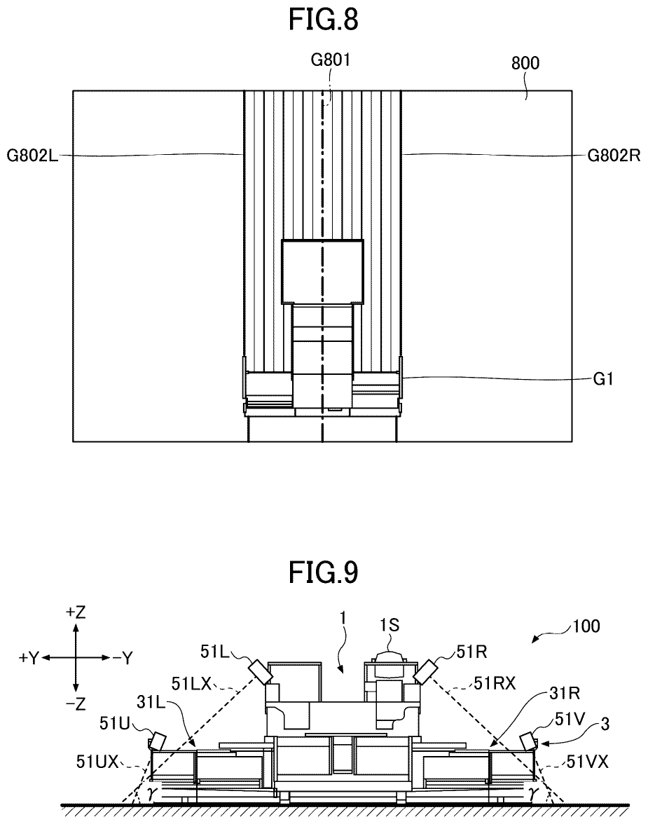

FIG. 8 is a drawing illustrating a bird's-eye view image generated by an information control part 50f according to the present embodiment. In the example shown in FIG. 8, the information control part 50f generates a bird's-eye view image from the image information captured by the imaging device 51. A well-known method may be used to generate the bird's-eye view image. Then, the information control part 50f superimposes an image G1 representing the asphalt finisher 100 on the generated bird's-eye view image.

The information control part 50f superimposes on the bird's-eye view image data images G802R and G802L indicating the boundary line between the milled surface and the road shoulder identified by the milled surface identification part 50b (e.g., an image showing a thick line). Furthermore, the information control part 50f superimposes on the bird's-eye view image data images G801 indicating the reference line generated by the reference line generation part 50c (e. g., an image showing a long dashed short dashed line).

Thus, when the user refers to the bird's-eye view image, a relation between the milled surface captured in the bird's-eye view image and the reference line and boundary line superimposed on the bird's-eye view image can be recognized. In other words, by confirming whether or not the reference line is superimposed along the milled surface, the user can grasp whether or not the asphalt finisher 100 can move along the milled surface as of the current time. Specifically, when there is little difference in height between the milled surface and the road surface which is not milled, it may be difficult for the user to grasp the difference in the bird's-eye view image generated from the image information captured by the imaging device 51. Conversely, in the bird's eye view shown in FIG. 8, the images G802R and G802L are superimposed on the boundary line. Therefore, by superimposing the images G802R and G802L as virtual visual information on the bird's eye view in which the real space is represented, the controller 50 augments the real world and facilitates for the user to recognize a surrounding situation of an object to be executed by the asphalt finisher 100.

Returning to FIG. 3, the communication control part 50g controls transmission and reception of information with an external device using the communication device 53.

### <Remote Monitoring>

There is a method in which the communication control part 50g transmits and receives information for remote monitoring of the asphalt finisher 100 with the communication terminal 200 or the remote management device 300 using the communication device 53.

For example, the communication control part 50g transmits a bird's-eye view image as shown in FIG. 8 to the communication terminal 200 as an example of image information showing the current execution status. The user the work at site has the communication terminal 200.

Furthermore, the communication control part 50g receives information for controlling the steering angle or speed of the asphalt finisher 100 from the communication terminal 200. The movement control part 50d outputs a control command based on the received information to the drive system controller 54. Thus, remote control of the asphalt finisher 100 can be achieved from the communication terminal 200 or the remote management device 300.

That is, by using the communication terminal 200, the user can determine whether the moving direction of the asphalt finisher 100 is appropriate by referring to the bird's-eye view image. When the user judges that the moving direction of the asphalt finisher 100 is not appropriate, information for controlling steering or speed can be transmitted from the communication terminal 200 to the asphalt finisher 100. Thus, path correction of the asphalt finisher 100 can be performed. Therefore, in the present embodiment, remote monitoring of whether or not the asphalt finisher 100 is properly executed on the milled surface can be achieved.

That is, in the road surface paving system SYS according to the present embodiment, proper execution can be achieved without the user being on the asphalt finisher 100.

### <User Boarding>

There is also a method in which the user is on the asphalt finisher 100. At this time, there is also a method in which automatic movement control is performed so that the asphalt finisher 100 moves along the milled surface by the above-described control. There is also a method in which the display device 52 of the asphalt finisher 100 displays the above-described bird's-eye view image data. Thus, the user can confirm the moving direction of the asphalt finisher 100. Furthermore, when the user recognizes that the moving direction by the automatic movement control is wrong, there is a method of directly operating the asphalt finisher 100 using the operation panel 65 or a handle (not shown). Thus, the asphalt finisher 100 performs path correction so as to move along the milled surface.

### <Log Storage>

In the present embodiment, a method of recording the execution result performed by the asphalt finisher 100 as a log is used. For example, there is a method in which the information control part 50f records the length of the milled surface identified by the milled surface identification part 50b in the vehicle width direction in the log information storage part 48a as the work width in which the operation was performed. In other words, the asphalt finisher 100 according to the present embodiment performs a process so as to pave the identified milled surface. Thus, the identified milled surface becomes a paved area.

Then, the information control part 50f records log information indicating the length of the milled surface identified by the milled surface identification part 50b in the vehicle width direction (the length between the boundary lines) in the log information storage part 48a provided in the auxiliary storage device 48 as the working width paved with the paving material (an example of a processing result). In the present embodiment, the working width paved with the paving material (an example of the processing result) is recorded as log information in the log information storage part 48a, but the information about the working width (an example of the processing result) need not be recorded as log information. As a variation, there is also a method of transmitting the information about the working width (an example of the processing result) to a management device that manages the log information.

Furthermore, there is a method of managing the log information recorded in the log information storage part 48a by an external device. In the present embodiment, recording and management of the log information facilitates the management of the information related to the area where the execution has been carried out, so the workload can be reduced.

For example, there is a method of transmitting the log information recorded in the log information storage part 48a to the remote management device 300 every predetermined time by the communication control part 50g. There is also a method of transmitting to the communication terminal 200 and a cloud service, for example, without limiting transmission to the remote management device 300.

The road surface paving system SYS according to the present embodiment can confirm whether or not the milled surface has been properly identified by the asphalt finisher 100 by managing log information about the asphalt finisher 100. Therefore, the user can recognize whether or not the execution has been properly performed.

In the present embodiment, an aspect has been described in which the milled surface is identified based on the milling marks shown in the image information, and the reference line for the asphalt finisher 100 to move is identified based on the milled surface. However, the present embodiment shows an aspect of identifying the reference line for the asphalt finisher 100 to move based on the milled surface, and other methods may be used. For example, there is a method for identifying the reference line for the asphalt finisher 100 to move by combining the milled surface identified based on the milling marks shown in the image information and the execution data in which the area to be executed by the asphalt finisher 100 is defined. Since the execution data includes information about a height to be paved by the asphalt finisher 100 with the paving material, the road surface can be executed with higher accuracy. Furthermore, the present embodiment is not limited to the method of identifying the milled surface in order to identify the reference line. As a variation, there is also a method for identifying the reference line for the asphalt finisher 100 to move based on the boundary lines 402R and 402L by extracting the difference between the area where the milling marks are shown and the area where the milling marks are not made and identifying the boundary lines 402R and 402L based on the difference. In other words, the controller 50 needs only to find the milled area based on the milling marks represented in the image information and identify the reference line.

### Variation of One Embodiment

In the above-described embodiment, an example in which the movement control of the asphalt finisher 100 is based on the identified execution surface, and the extension and retraction control of the left retractable screed 31L and the right retractable screed 31R in the vehicle width direction are performed is described. However, the method is not limited to performing both the movement control and the extension and retraction control as described in the aforementioned embodiment; there may be methods that involve performing either one of them. Therefore, the present variation is an example that only involves performing the movement control of the asphalt finisher 100.

In the present variation, as in the above-described embodiment, the controller 50 identifies the milled surface from the milling marks shown in the image information, and generates a reference line based on the milled surface. Then, the controller 50 outputs a control command to the drive system controller 54 so as to move along the reference line.

Additionally, the extension and retraction control of the left retractable screed 31L and the right retractable screed 31R is performed by user operation. The user who performs the operation may be a user who has boarded at the rear of the asphalt finisher 100 to operate the screed 3, or a user sitting in the driver's seat 1S of the asphalt finisher 100.

Also, in the present variation, an example in which the controller 50 performs the movement control and the user performs the extension and retraction control has been explained. However, the aspect shown in the present variation is not limited to this, and for example, there is a method in which the user performs the movement control and the controller 50 performs the extension and retraction control.

### Another Variation of One Embodiment

In the present variation, a case in which a trained model generated by machine learning is used as a method in which the milled surface identification part 50b identifies the milled surface based on the milling marks shown in the image information will be described. In the method in which the milled surface is identified using the trained model generated by machine learning, it is not necessary to prepare all the image information showing the milling marks by the road surface milling machine as compared with the method in which pattern matching is performed, and the workload can be reduced.

In the present embodiment, there is a method in which a learning device for performing machine learning is provided as the road surface paving system SYS. The learning device may be, for example, an on-premises server installed in a remote monitoring area or a cloud service.

The learning device generates a trained model by performing machine learning using image information in which a milled surface is indicated by annotation and image information in which a milled surface does not exist as training data. Annotation for the milled surface is set by the user identifying an area where milling marks appear. As the machine learning, for example, deep learning may be applied. Specifically, as the machine learning, a method for performing learning by back-propagation using a neural network may be considered, but other methods may be used.

When image information is input, the trained model outputs information identifying the milled surface present in the image information.

The learning device outputs the trained model to the asphalt finisher 100. The output method may be any aspect. For example, it may be transmitted via a public network, or it may be stored in the auxiliary storage device 48 via a detachable nonvolatile memory.

The trained model is stored in the auxiliary storage device 48 of the asphalt finisher 100.

By inputting image information to the trained model stored in the auxiliary storage device 48, the milled surface identification part 50b of the asphalt finisher 100 of the present variation acquires information identifying the milled surface shown in the image information.

For example, the milling marks appearing on the milled surface differ depending on the type of road surface milling machine. Therefore, in the present variation, the trained model acquired by performing machine learning on the milling marks corresponding to the type of road surface milling machine used at the work site is stored in the asphalt finisher 100. As a result, the milled surface can be identified based on the milling marks represented at the work site, and the accuracy of identifying the milled surface can be improved.

Furthermore, there is a method for updating the trained model as needed. For example, when an erroneous detection occurs in the identification of the milled surface based on the image information by the milled surface identification part 50b, the erroneous image information is output to the learning device.

There is a method for re-learning by inputting the training data identifying a correct milled surface in the image information by the learning device. There is a method for identifying the milled surface with respect to the image information by the user.

The trained model that has re-learned is stored in the auxiliary storage device 48 of the asphalt finisher 100. In the present variation, the accuracy of detecting the milled surface can be improved by re-learning.

In the present variation, by using the trained model for identifying the milled surface, the workload for creating a program for detecting the milled surface can be reduced. In addition, when the trained model is used, the training data used for learning can be added and updated as needed, so that the accuracy of detecting the milled surface can be improved.

### Another Embodiment

In the above-described embodiment, the example of identifying the milled surface based on the image information captured by the front camera 51F has been described. However, the image information used for identifying the milled surface is not limited to the image information captured by the front camera 51F. Therefore, in another embodiment, an example in which imaging devices are provided near the distal ends of the left retractable screed 31L and right retractable screed 31R, respectively, will be described.

FIG. 9 is a rear view of the asphalt finisher 100 according to the present embodiment. In the example shown in FIG. 9, in addition to the front camera 51F, the left camera 51L, and the right camera 51R shown in one embodiment, the left auxiliary camera 51U and the right auxiliary camera 51V are provided.

The left auxiliary camera (an example of a detection device) 51U is provided near the end of the distal end of the left retractable screed 31L in the upward direction (+Z direction). The optical axis 51UX of the left auxiliary camera 51U faces downward. Thus, the imaging range of the left auxiliary camera 51U includes the boundary line between the left (+Y direction) end of the milled surface and the road shoulder, and the side plate 71 of the left retractable screed 31L.

The right auxiliary camera (example of a detection device) 51V is provided near the end of the distal end of the right retractable screed 31R in the upward direction (+Z direction). The optical axis 51VX of the right auxiliary camera 51V faces downward. Thus, the imaging range of the right auxiliary camera 51V includes the boundary line between the right (−Y direction) end of the milled surface and the road shoulder, and the side plate 71 of the right retractable screed 31R.

The controller 50 of the asphalt finisher 100 according to the present embodiment has the same configuration as that of one embodiment.

In addition to the process of one embodiment, the acquisition part 50a acquires image information from the left auxiliary camera 51U and the right auxiliary camera 51V.

The milled surface identification part 50b identifies the milled surface from the image information acquired from each of the left auxiliary camera 51U and the right auxiliary camera 51V. At this time, the milled surface identification part 50b also identifies the boundary line between the milled surface and the road shoulder. When the milled surface identification part 50b identifies the milled surface from the image information acquired from each of the left auxiliary camera 51U and the right auxiliary camera 51V, there is a method of calculating a deviation amount between the side plate 71 (an example of the end of the screed) and the boundary line.

The screed control part 50e outputs a control command for extending and contracting the retractable screed 31 to the screed control device 55 based on the boundary line (an example of the length of the milled surface in the vehicle width direction) identified by the milled surface identification part 50b. For example, the screed control part 50e outputs a control command for extending and contracting the retractable screed 31 to the screed control device 55 so as to reduce the deviation amount between the side plate 71 (an example of the end of the screed) and the boundary line identified by the milled surface identification part 50b.

In the present embodiment, by providing the left auxiliary camera 51U and the right auxiliary camera 51V at the distal end of the retractable screed 31, the detection accuracy of the position of the boundary line is improved. Therefore, since the extension and retraction control of the retractable screed 31 can be achieved according to the milled surface, the execution accuracy of the road surface can be improved.

In the above-described embodiment, the position where the imaging device is installed is shown as an example, and is not limited to the above-described position, but may be any position as long as at least a part of the milled surface (e.g., boundary line) is included in the imaging range. For example, there is a method of installing the imaging device at the distal end of a rod-shaped member extended from the asphalt finisher 100 in the vehicle width direction.

### <Action>

According to the asphalt finisher 100 according to the above-described embodiment, the milled surface to be executed can be identified according to the milling marks represented in the image information. Then, the asphalt finisher 100 performs a process of paving the milled surface with a paving material, so that the milled surface to which the paving material has been milled can be appropriately executed. Therefore, the execution accuracy can be improved.

In addition, since it is possible to appropriately perform an execution process on the detected milled surface, either the movement control of the asphalt finisher 100 or the extension and retraction control of the screed 3 becomes easy. Therefore, it is possible to reduce the workload of the occupant or the operator of the asphalt finisher 100.

Although the embodiments of the working machine and the road surface paving system according to the present invention have been described above, it should be understood that the invention is not limited to the above-described embodiments, but may be modified into various forms on the basis of the spirit of the invention. Additionally, the modifications are included in the scope of the invention.

What is claimed is:

1. A road machine comprising:
a tractor;
a screed disposed behind the tractor and configured to level a first paving material; and
a working device configured to supply the first paving material in front of the screed,
wherein the road machine is configured to perform a process for paving an area having milling marks with the first paving material based on the milling marks on a second paving material, the second paving material having been used to pave a road surface, and the milling marks being shown in image information captured by an imaging device.

2. The road machine according to claim 1, wherein the road machine is configured to identify, based on the milling marks, a milled surface that represents an area where the second paving material has been milled, and perform a process for paving the milled surface included in the road surface with the first paving material.

3. The road machine according to claim 2, wherein the road machine is configured to move the tractor along a path determined based on the identified milled surface, as the process for paving the area having milling marks with the first paving material.

4. The road machine according to claim 3, wherein a center line between a plurality of boundary lines which are boundary lines of the milled surface in a vehicle width direction is used as the path of the road machine at a predetermined position.

5. The road machine according to claim 1, wherein the road machine is configured to move the tractor along a path determined based on a boundary line between an area where the milling marks exist and an area where the milling marks do not exist, represented by the image information, as the process for paving the area having milling marks with the first paving material.

6. The road machine according to claim 1, wherein:
the screed is capable of extending and retracting in a vehicle width direction of the road machine, and
the road machine is configured to control extension and retraction of the screed based on a length in the vehicle width direction of the area having milling marks, as the process for paving the area having milling marks with the first paving material.

7. The road machine according to claim 6, wherein:
the imaging device is provided near a distal end of the screed; and
the road machine is configured to control extension and retraction of the screed based on an end, in the vehicle width direction, of the area having milling marks, which is shown in the image information captured by the imaging device provided near the distal end of the screed.

8. The road machine according to claim 1, wherein the imaging device is attached near a distal end of the screed or an upper end of the tractor, or both.

9. The road machine according to claim 1, further comprising a storage part configured to store log information indicating a result of the process for paving the area where the milling marks have appeared with the first paving material.

10. The road machine according to claim 2, further comprising a trained model configured to output an area of the milled surface shown in the image information based on the image information captured by the imaging device, wherein the road machine is configured to identify the milled surface captured in the image information by inputting the image information captured by the imaging device provided on the road machine into the trained model.

11. A road surface paving system, comprising a road machine and a communication terminal, wherein the road machine includes:
a tractor;
a screed disposed behind the tractor and configured to level a first paving material;
a working device configured to supply the first paving material in front of the screed;
a communication part configured to receive or transmit information; and
a control part configured to perform a process for paving an area having milling marks with the first paving material based on the milling marks on a second paving material, the second paving material having been used to pave a road surface, and the milling marks being shown in image information captured by an imaging device,
wherein the communication terminal is configured to transmit or receive the information to and from the communication part provided on the road machine.
